(19) United States
(12) Patent Application Publication
(10) Pub. No.: US 2017/0167712 A1
(43) Pub. Date: Jun. 15, 2017

(54) HEADLIGHT WITH AN LED LIGHT SOURCE

(71) Applicant: ARNOLD & RICHTER CINE TECHNIK GMBH & CO. BETRIEBS KG, München (DE)

(72) Inventor: Erwin MELZNER, Frasdorf (DE)

(73) Assignee: ARNOLD & RICHTER CINE TECHNIK GMBH & CO. BETRIEBS KG, München (DE)

(21) Appl. No.: 15/327,032

(22) PCT Filed: Jul. 20, 2015
(86) PCT No.: PCT/EP2015/066539

§ 371 Date: Jan. 17, 2017

(30) Foreign Application Priority Data
Jul. 18, 2014 (DE) 20 2014 103 329.7

(51) Int. Cl. F21V 29/57; F21S 9/04; F21K 9/64; F21V 29/67; F21V 3/04; F21V 31/00; F21V 29/58; F21V 29/76

(52) U.S. Cl. CPC F21V 29/57; F21V 29/59; F21S 9/04; F21V 29/76; F21V 29/673; F21V 29/58; F21V 3/0481; F21V 31/00; F21K 9/64; F21Y 2115/10

(57) ABSTRACT

This invention relates to a headlight with an LED light source which contains at least one light-emitting diode arranged on a circuit board and is arranged in a housing enclosing the LED light source, which includes at least one light exit surface through which the light emitted by the LED light source exits. According to the invention it is provided that the housing encloses the LED light source in a liquid- or gas-tight way and includes at least one coolant inlet and one coolant outlet for a liquid or gaseous coolant.

### CROSS-REFERENCE TO A RELATED APPLICATION

This application is a National Phase Patent Application of International Patent Application Number PCT/EP2015/066539, filed on Jul. 20, 2015, which claims priority of German Patent Application DE 10 2014 103 329.7, filed on Jul. 18, 2014.

### BACKGROUND

This invention relates to a headlight with an LED light source.

The operation of LEDs just like that of electronic components such as processors, memory modules and the like involves a considerable power loss which is emitted in the form of heat. To reduce the overall size of LED light sources or electronic devices, the packing density of the LEDs or electronic components however is steadily increased, so that a large amount of heat is emitted in a confined space, which leads to an impairment of the function and useful life of the LEDs or electronic components. However, the same operate the more efficiently and have a longer useful life the cooler their operating temperature. Since the amount of heat emitted by the LEDs and electronic components however cannot always be tackled with an air cooling, liquid cooling systems are used for an increased dissipation of heat.

The most common form is the so-called single-phase indirect liquid cooling in which the coolant does not contact the heat sources. Such systems in the form of so-called circulating air cooling systems, where the coolant can be cooled down approximately to the temperature of the ambient air, also are available for Personal Computers as complete sets or as individual parts. In essence, they consist of the following components:
a coolant reservoir or tank for the coolant,
a coolant pump for the transport of the coolant,
a radiator with fan, by which the heat absorbed is dissipated to the ambient air, and
a cooler (e.g. CPU cooler), which is traversed by the coolant and which must be mounted on the heat-emitting component with as little thermal resistance as possible. The latter also is referred to as cooling plate.

An alternative with higher thermal power, which is used above all in the industry, is the so-called (single-phase) immersion cooling. The heat-emitting components are directly flowed around by a non-conductive coolant and emit their heat to the coolant. There are obtained two material layers, namely the housing material of the cooling plate itself and the heat intermediary, for example in the form of a heat-conducting paste, which must be incorporated between the cooling plate and the heat source, in order to compensate smaller irregularities of the surface. The thermal resistance between the heat source and the coolant is greatly reduced thereby, all surfaces are cooled and the cooling operates more efficiently than an indirect liquid cooling.

An even more efficient method is the so-called impact and spray cooling, in which the heat-emitting components are sprayed directly with the coolant.

Both for the indirect and for the direct cooling systems two-phase designs also are available. There is utilized the still higher thermal power, which is obtained by the phase transition of the coolant, e.g. when water evaporates. Such cooling systems are known for example under the designations boiling water cooling or evaporation cooling.

When it is required that the cooler or the coolant be cooled down to below the temperature of the ambient air, a two-circuit cooling system must be used. This also applies when the temperature of the cooling plate or the coolant must be controlled precisely. It then also is common practice to use a recooling system or a water exchange system.

Beside the primary coolant circuit, a recooling system also has a secondary refrigerant circuit. The coolant is cooled by the refrigerant when it passes through an evaporator. The refrigerant absorbs the thermal energy, evaporates and is liquefied again by means of a compressor and a condenser. During the condensation, the heat is emitted to the ambient air via a radiator with fan.

In a water exchange system the coolant is passed from the primary circuit through a heat exchanger, where it is cooled by the colder process water. The process water is supplied from outside.

In studio lighting and in particular in professional film lighting there is a demand for very powerful LED headlights analogous to the “daylight projectors” used nowadays. As lamps, such headlights have so-called halogen metal vapor lamps with powers of 575 W or more and with luminous fluxes of 49,000 lm or more. The luminous spots of these lamps, i.e. the light-producing plasms, have a size of only few millimeters, so that extremely high luminous densities are achieved.

In the application as “spot headlights” light cones with half peak angles of 10° or less often are required. Due to the optical laws, there are required reflectors or lenses which are the larger the larger the light source is and the smaller the half peak angle is. To be able to build compact and handleable LED spot headlights, LED light sources more compact than those available nowadays are required. From a certain power density, however, the same require particular cooling measures.

In the field of the professional lighting with LED light sources an indirect water cooling therefore already is used occasionally, in order to cool compact LED arrays with a power of about 25 W to 100 W within LED headlights. According to the schematic representation in FIGS. 17 to 20, an LED light source 1 soldered onto a circuit board 2 therefor is mounted on a cooling plate 3′ which is traversed by cooling water via inlets and outlets 31, 32. When the LED light source 1 is mounted in front of a Fresnel lens and is movably mounted along the optical axis of an LED headlight, an LED headlight focussable in a wide range from less than 10° to more than 60° thereby is obtained with simple means.

FIG. 20 shows such prior art cooling system in a schematic functional representation. The LED light source 1 is thermally coupled with a cooling plate 3′ which is connected to a coolant line 8. To produce a large heat-emitting surface, the coolant line 8 is thermally coupled with a heat sink 71, wherein a fan 70 produces a cooling air stream which for recooling the coolant flowing in the coolant line 8 produces a cooling air stream directed onto the heat sink 71. The circulating air cooling device 7 furthermore includes a coolant reservoir 72 for the coolant and a coolant pump 73 for producing a circulating stream of coolant.

The power supply of the LED light source 1 is effected via a power supply cable 14 which is connected with an electronic controller, a mains unit or ballast 12 which is connected with a power supply unit via a mains cable 13.

An essential disadvantage of the indirect water cooling described above consists in that the power density of the LED light source is limited by the thermal conductivity of the used materials of the circuit board accommodating the LED light source and of the cooling plate. Such cooling system no longer is suitable for cooling compact LED light sources whose power density lies above about 50 W/cm².

### SUMMARY

It therefore it is the object underlying the present invention to provide a headlight with an LED light source as mentioned above, which with a compact construction provides for a high power density with a long service life at the same time.

According to the invention, this object is solved by the subject-matter as described herein.

The solution according to the invention realizes a headlight with a compact LED light source which provides for a high power density of for example more than about 50 W/cm² without limitation of the useful life or the optical properties of an LED headlight, as the light-emitting diodes arranged on a circuit board are disposed in a housing enclosing the same in a liquid- or gas-tight way, which includes at least one light exit surface through which the light emitted by the LED light source exits, and which on its walls has housing openings which are formed as coolant inlet and coolant outlet for a liquid or gaseous coolant.

To achieve an optimum through-flow of the housing and hence cooling of the LED light source, the coolant inlet and the coolant outlet preferably are diametrically arranged relative to each other on the side walls of the housing between the circuit board and the light exit surface. As an alternative, however, a non-diametrical arrangement of the coolant inlet and the coolant outlet on side-, rear and front walls of the housing also is possible, possibly in conjunction with flow guiding webs.

Alternatively, the housing can enclose both the LED light source and a cooling element connected with the circuit board, in particular consisting of cooling ribs, so that a coolant flows around both the LED light source and the cooling element and emits the heat absorbed via a cooling system to the environment or to a device absorbing heat.

As LEDs, finished light-emitting diodes (“packages”) in a ceramic or plastic housing can be used, which are mounted on a circuit board. As an alternative, LED chips or dies without housing can be used, which are mounted on a circuit board by means of chip-on-board technology. LED chips and finished LEDs can be covered with an optically inactive material, such as e.g. silicone, or with an optically active material, such as e.g. a luminescent material. This material can be applied directly onto the chips or finished LEDs, like in the applied-phosphor technology, or it can be applied onto a carrier material at a certain distance, like in the remote-phosphor technology.

To support the cooling effect it is advantageous to furthermore mount the LED light source on a circuit board of very good thermal conductivity, in particular on a so-called metal core printed circuit board (MCPCB), which consists of a core of aluminum or copper, a dielectric of rather good thermal conductivity, and a copper coating with soldering surfaces. As an alternative, there can also be used a ceramic board with integrated metallic soldering surfaces. Cooling of the circuit board advantageously is effected with a metallic cooling plate which is traversed by a cooling liquid and which is thermally coupled with the rear side of the circuit board facing away from the LED light source.

To increase the cooling effect on the LED light source to the required extent, it is necessary in addition to bring the coolant in direct contact with the LED light source. The LED light source therefore is surrounded by a liquid- or gas-tight housing which has one or more inlets and outlets for the coolant, which directly flows around the LED light source. As coolant, non-conducting and non-corrosive liquids with high thermal capacity preferably can be used, such as fluorosurfactants or ultrapure water with anti-corrosive additives.

To be able to also optically utilize the light of the LED light source, the housing is provided with a window of glass, of transparent optical plastics or the like, which likewise is incorporated tightly. The optical window can consist of a plane-parallel plate or also of a structure with curved or stepped surfaces, such as e.g. a lens, a lens array or a light mixing rod (taper), so that a certain beam formation and/or color mixing already is carried out at this point. A dynamic beam formation can be achieved by an optical window which is arranged in front of the LED light source in a liquid-tight, but movable way.

The optical window can be coated with a luminescent material according to the remote-phosphor technology as mentioned above, which e.g. converts the light emitted by blue LEDs into white light.

The optical window, the surface and possibly the primary optics of the LED light source as well as the cooling liquid also must be adjusted to each other in terms of their refractive index and their spectral transmission and spectral reflection, in order to achieve the desired lighting result, such as a certain radiation angle or a certain luminous efficiency.

Furthermore, it can be required to incorporate further optical elements such as e.g. reflectors and diaphragms into the housing.

The LED light source itself preferably is flowed around by an inert liquid as coolant with particular thermal and optical properties, while for cooling via the cooling plate water with suitable additives usually is employed to avoid calcification and corrosion. To achieve an optimum cooling result under certain framework conditions, such as e.g. a maximum overall size, it can therefore be expedient to build up a two-stage cooling system, consisting of a primary circuit with water as cooling medium, a secondary circuit with the cooling medium suitable for cooling the LED light source, and a heat exchanger.

The cooling circuits for cooling the circuit board and for cooling the LED light source can, however, also be combined in one cooling circuit and be connected in series or in parallel therewith, when in both circuits the same inert coolant is used.

The light emitted by the LEDs changes in dependence on the temperature of the semiconductor layer. It is known that not only the brightness of the LEDs decreases with increasing temperature, but that the spectrum also is shifted, so that the color locus of a hot LED light source deviates from the color locus of the same, but cold LED light source. To compensate these effects, a multicolor LED light source with a temperature-controlled electronic regulation corresponding to WO 2009/034060 can be built up, with which the color locus is kept stable with high accuracy via the temperature.

When a liquid cooling system and in particular a recooling system or water exchange system is used, it also is possible to stabilize the temperature of the LED light source by regulating the coolant temperature or the coolant flow to such an extent that the regulation of the electronic actuation of the LEDs can be omitted. In a circulating air cooling system the fan also can be regulated, so that the emission of heat to the ambient air is controlled therewith.

In this way the expenditure for the hardware and software is greatly reduced, as it no longer is necessary to regulate every single color channel, but only the coolant temperature or the coolant flow and possibly the rotational speed of the fan at the radiator. As the temperature of the coolant usually lies in a range of about 40-60° C., the LEDs also are exposed to a lower thermal load and achieve a longer useful life.

In a particular embodiment a mixed operation between the two regulation systems also can be expedient. When the cooling system e.g is designed in a compact construction for normal operation up to a certain ambient temperature, it is possible to employ the coolant regulation and LED stabilization as described above up to this temperature. From this temperature, an intensive operation can then be started, at which the color locus of the LEDs is stabilized via their electronic actuation.

As after passing at least one lens or reflector the light emitted by the LED light source is radiated into the far field, where it possibly impinges on a large receiving surface (scene, actor, or the like), it must also have a spatially and temporally homogeneous brightness and color distribution. Therefore, in general neither static light spots nor shadows or color spots as well as temporal fluctuations of the brightness or color are admissible. This can only be achieved when the coolant itself also is homogeneous, i.e. includes no suspended particles or density fluctuations, and when it is moved and heated within the housing in a controlled way such that no optically effective density fluctuations occur, which would lead to billowing or flickering in the light field. It must also be avoided that the coolant boils already at the LEDs, as then—possibly also only microscopically small—bubbles are obtained, which deteriorate both the dissipation of heat and the light output. Therefore, a laminar flow with little temperature difference between coolant inlet and coolant outlet is desirable.

For heat dissipation, the cooling system includes at least one recooling device with a coolant reservoir, a coolant pump, a heat sink, cooling fins or cooling ribs and a fan.

Alternatively, the entire cooling system or a part of the heat exchanger can be formed as heat-absorbing cold pack, which is flange-mounted to the light source or to the coolant line, absorbs and then exchanges thermal energy for a limited period of time, i.e. is replaced by a cold pack prepared for the absorption of thermal energy.

From a certain power loss the weight, the overall size or the noise of the coolant pump and the fan blowing at the heat sink and cooling fins or cooling ribs is so large that no handleable LED headlight can be built anymore. The limiting factor here is the heat transfer coefficient from the heat sink and the cooling fins or cooling ribs to the ambient air. Therefore, a compromise between weight, size and loudness is sought, which in the case of professional studio and film headlights means that the cooling system or the recooling device comprising coolant reservoir, coolant pump, cooling fins or cooling ribs and fan no longer is incorporated into the LED headlight, but is operated and installed outside the LED headlight.

In headlights which are used in fixed installations, such as in a television studio, a water exchange system consisting of a central cooling device and a central coolant distribution similar to a fire-extinguishing sprinkler system can be installed. The LED headlights therefor require standardized coolant ports for the entry and exit, and an electronic and possibly software-related interface for the control and regulation.

In LED headlights for mobile use, such as e.g. LED headlights used on a film set or at events, the power supply for the LED headlight—which today is provided by a so-called ballast—and the cooling system is incorporated into a common appliance according to a further feature of the invention. The combined supply and cooling system then can be set up like a ballast remote from the LED headlight and from the possibly noise-sensitive environment. The power supply lines, the cooling hoses and the interface for the control and regulation of the cooling system then lead to the LED headlight.

For particular purposes it also is expedient to integrate the various functional units of the cooling system, such as e.g. the coolant reservoir or the coolant pump, into various systems or appliances. Thus, e.g. a central cooling system can perform the dissipation of the heat to the ambient air, while the LED headlights themselves only are equipped with a coolant pump or an auxiliary pump and a heat exchanger. A two-stage cooling system also can be constructed such that the components of the recooling system are arranged outside the LED headlight, while e.g. the cooling plate and the secondary circuit are incorporated in the LED headlight itself in a space-saving way.

The supply voltage, the electrical control signals or interfaces and the coolant hoses advantageously are combined in a single hybrid cable, in order to facilitate handling.

When a larger number of LED headlights is required on a film set and when the power input and the quality of the existing power supply are not sufficient, generator vehicles in general are used for the supply. The generators in this case supply the mains voltage with which the LED headlights are operated directly or via their ballasts. For this case of application it is advantageous to arrange a central cooling unit with a central coolant distribution and coolant regulation in the generator vehicle, to which the LED headlights are connected. Individual combined supply and cooling systems thus are not required in such configuration and the existing ballasts or mains units can be operated further. The generator vehicle thus provides the mains voltage supply and the coolant supply and/or refrigerant supply for all connected LED headlights.

### BRIEF DESCRIPTION OF THE DRAWINGS

With reference to exemplary embodiments illustrated in the drawing the idea underlying the invention will be explained in detail. In the drawing:

FIGS. 1 to 3 show a side view, isometric view and top view of an LED light source with LEDs mounted on a cooled circuit board, surrounded by a liquid-tight housing and flowed around by an inert coolant;

FIGS. 4 to 6 show various optical windows in the housing surrounding the LEDs in a section along line A-A according to FIG. 3;

FIGS. 7 to 9 show a side view, isometric view and top view of an LED light source with a housing surrounding a circuit board with LEDs mounted thereon and a cooling plate, which is traversed by a coolant flowing in a cooling circuit;

FIG. 10 shows a longitudinal section through the LED light source along line B-B according to FIG. 9;

FIGS. 11 to 15 show a schematic representation of a cooling circuit of an inert coolant flowing through a cooling plate, which is thermally coupled with a circuit board with LEDs mounted thereon, and/or flowing around the LEDs and recooled in a recooling device;

FIG. 16 shows a schematic representation of a primary cooling circuit flowing through the cooling plate, which is thermally coupled with the circuit board accommodating the LEDs, and of a secondary cooling circuit connected with the primary cooling circuit via a heat exchanger, which flows around the LEDs mounted on the circuit board; and

FIGS. 17 to 20 show a schematic representation of a cooling system according to the prior art with a cooling plate traversed by a coolant, which is thermally coupled with a circuit board accommodating the LEDs.

### DETAILED DESCRIPTION

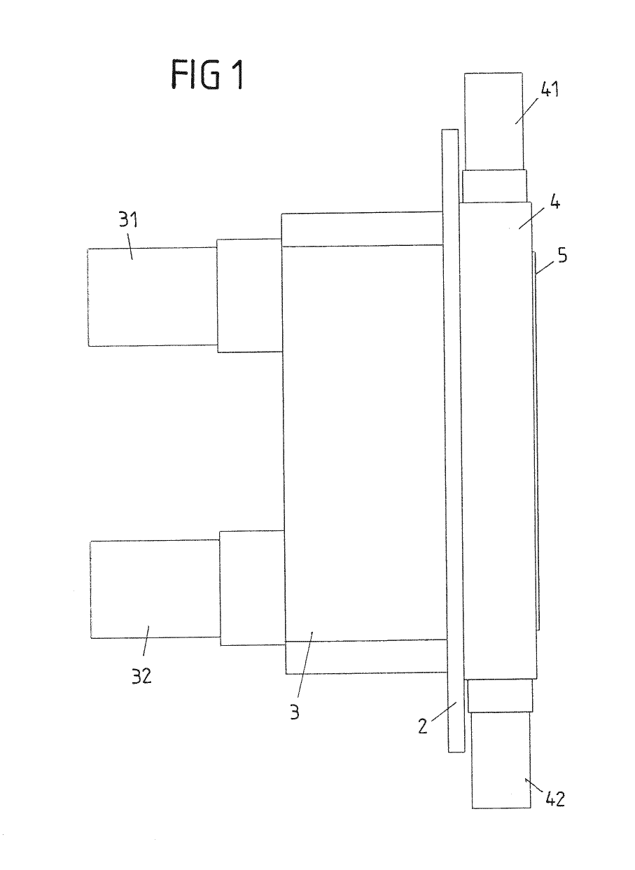

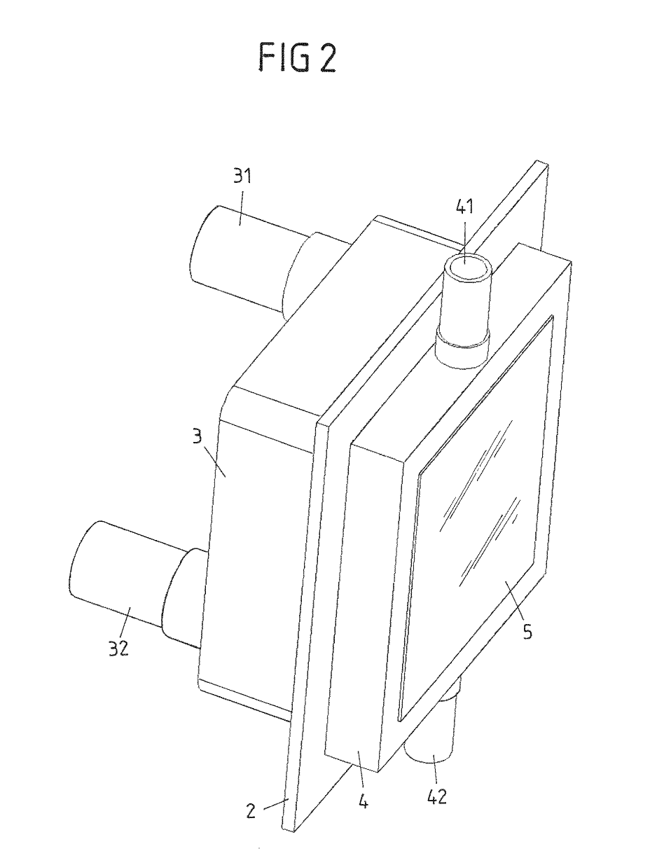

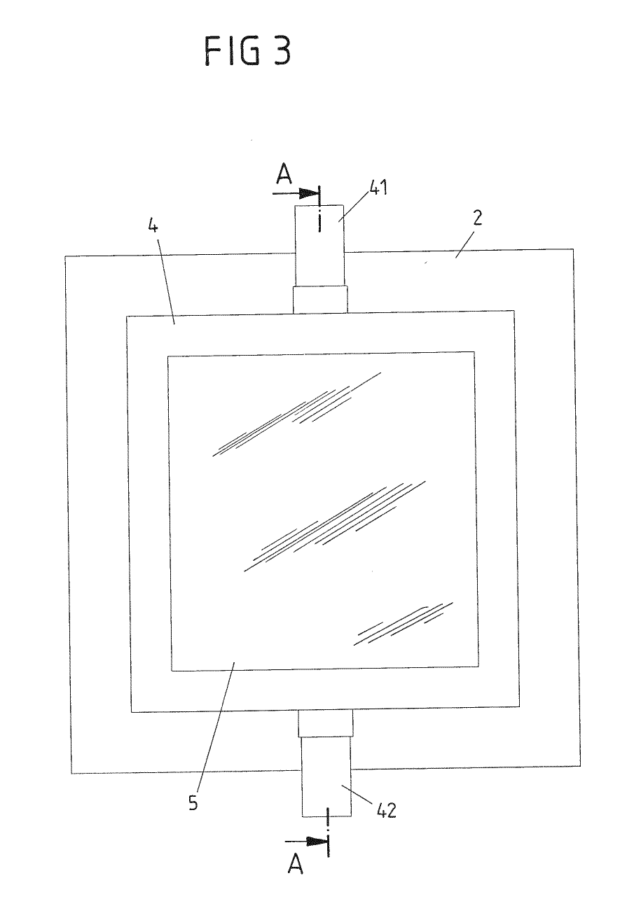

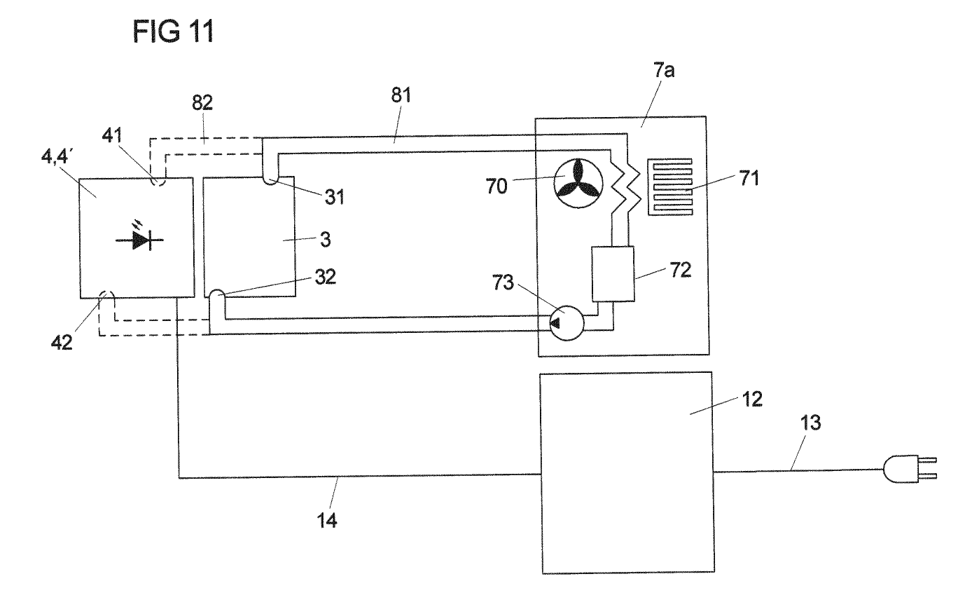

The first embodiment shown in FIGS. 1 to 6 in various views and in a longitudinal section to represent a direct cooling of an LED light source 1 mounted on a circuit board 2 includes a cooler 3 thermally closely coupled with the circuit board 2, which is traversed by a coolant which is guided in a first coolant line 81 which is coupled with the cooler 3 via a first coolant inlet 31 and a first coolant outlet 32. According to FIGS. 11 to 15 the heat absorbed by the coolant is emitted to the environment or to a heat-absorbing device by means of a cooling system 7a to 7e, so that in operation of the LED light source 1 a substantially constant temperature can be adjusted at the circuit board 2 with the LEDs mounted thereon.

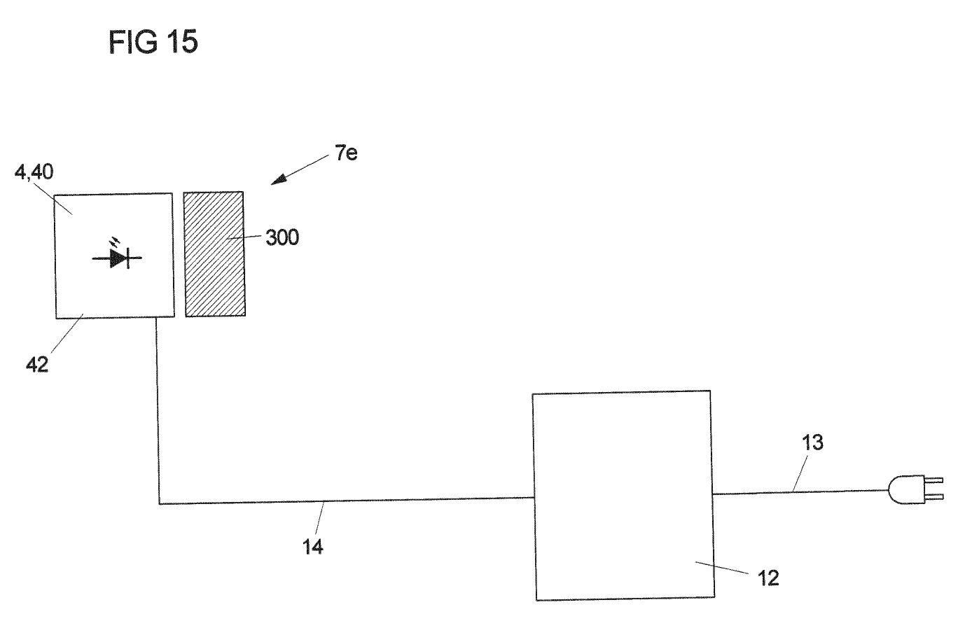

The LEDs of the LED light source 1, which are mounted on the circuit board 2 as finished light-emitting diodes in a ceramic or plastic housing or alternatively are mounted on the circuit board 2 as LED chips without housing by means of a chip-on-board technology, are surrounded by a preferably flat, generally cuboid or circular housing 4 adapted to the shape of the LED light source 1, which via a second coolant inlet 41 and a second coolant outlet 42 is connected with a second coolant line 82 of a cooling system 7a to 7d according to FIGS. 11 to 14, so that the cooling liquid guided in the first coolant line 81 directly flows around the LEDs of the LED light source 1. Via the cooling system 7a to 7d the heat absorbed by the coolant is emitted to the environment or to a heat-absorbing device. Alternatively, a heat-absorbing device in the form of a cold pack 300 corresponding to the schematic representation in FIG. 15 also can directly by flange-mounted to the LED light source 1.

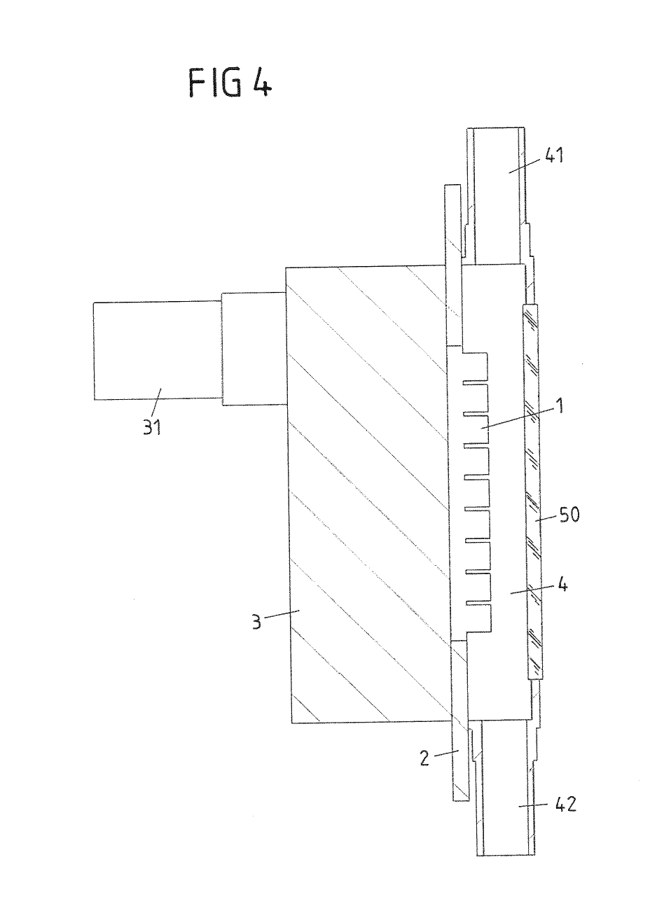

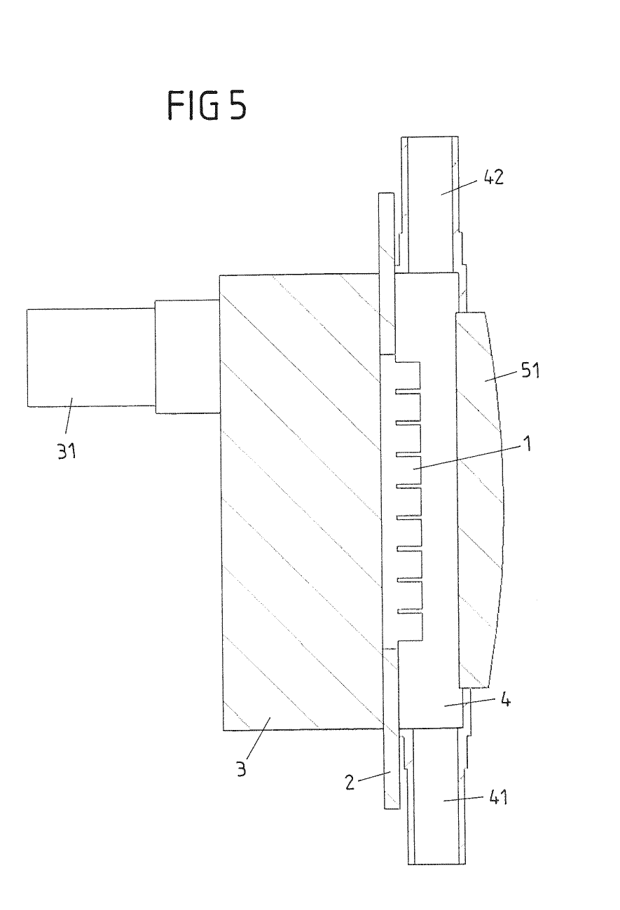

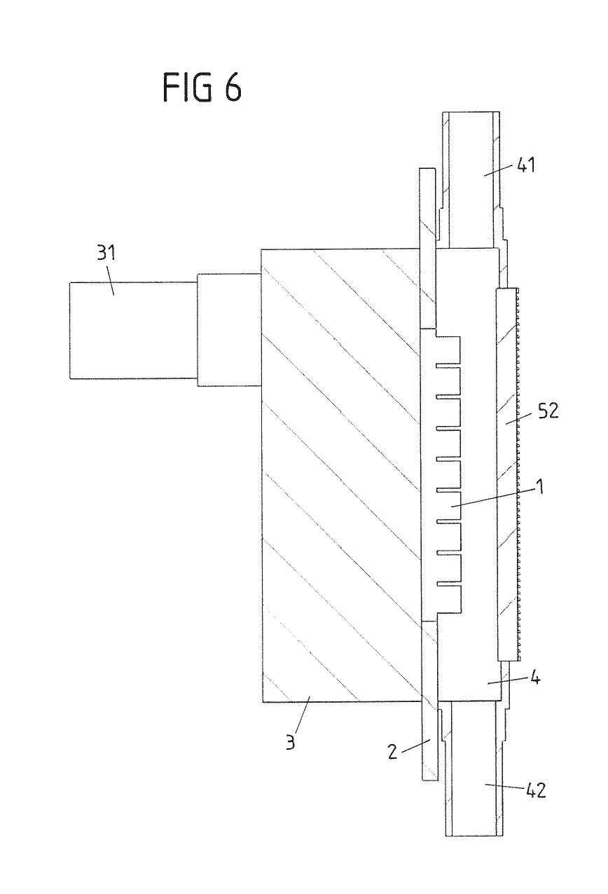

For radiating the light emitted by the LEDs of the LED light source 1 the surface of the wall of the housing 4 surrounding the LED light source 1, which faces the LED light source 1, includes an optical window 5 which can have different optical properties and according to FIG. 4 can consist of a plane-parallel glass or plastic plate 50 or of a structure with curved or stepped surfaces such as e.g. a lens 51 according to FIG. 5, a lens array, a scattering plate 52 according to FIG. 6, or of a light mixing rod, in order to perform a beam formation and/or color mixing already at the optical window 5. In addition, a dynamic beam formation can be achieved by an optical window arranged in front of the LED light source 1 in a fluid-tight, but movable way.

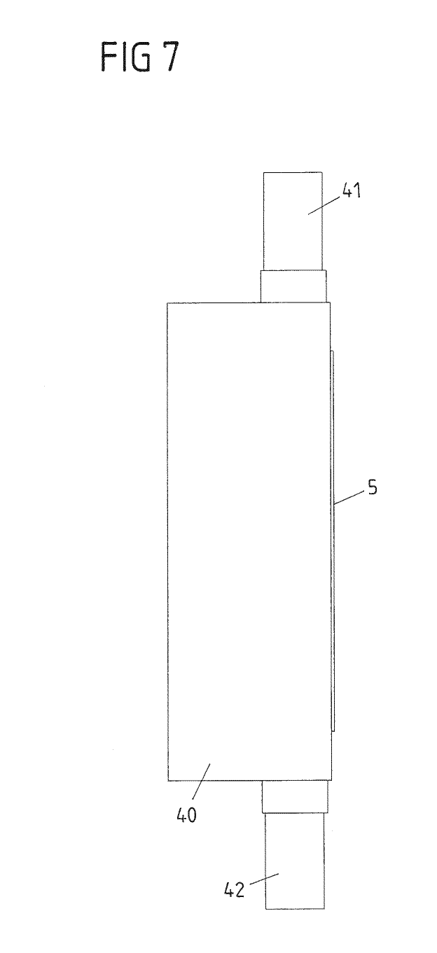

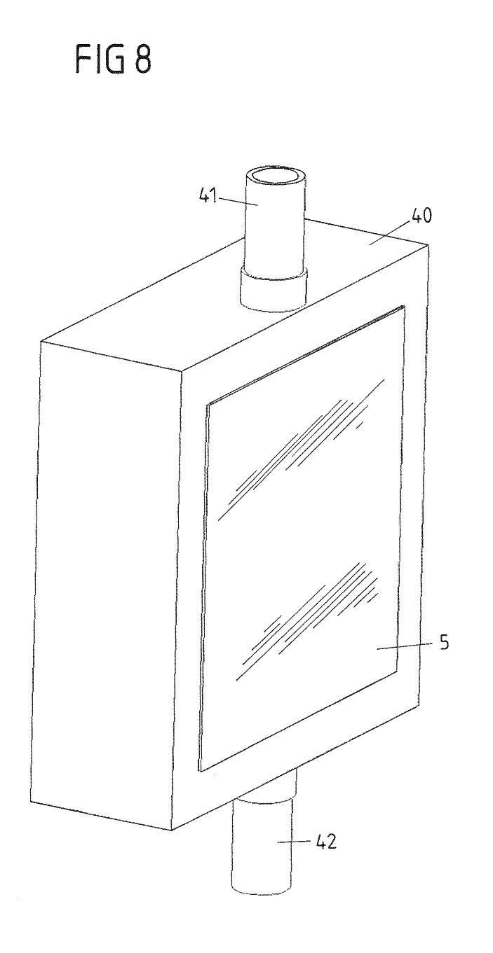

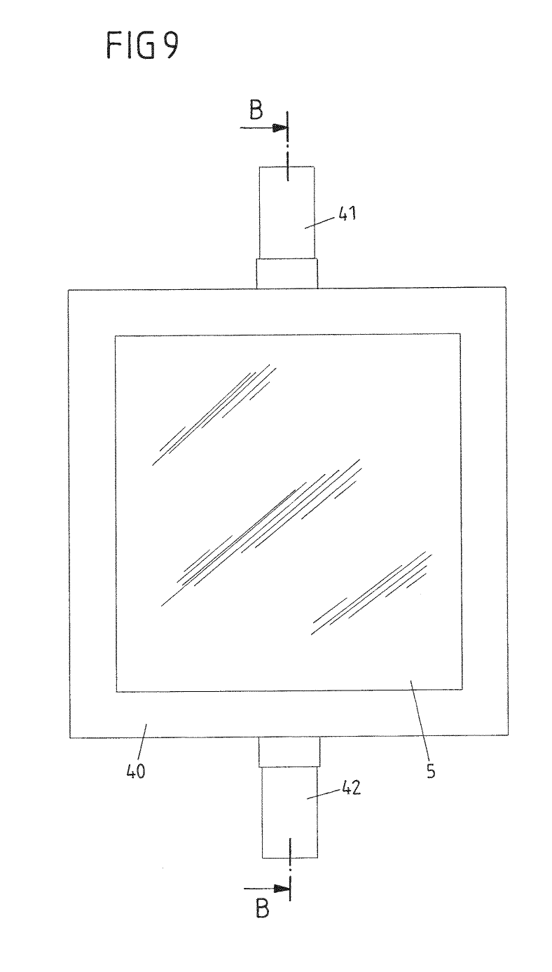

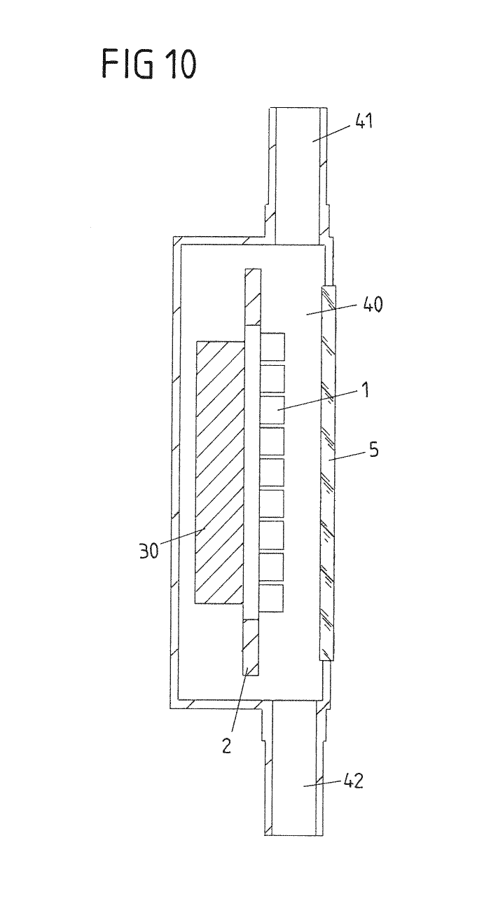

The second exemplary embodiment of an LED light source 1 as shown in FIGS. 7 to 10 in various views and in a longitudinal section differs from the first exemplary embodiment described above with reference to FIGS. 1 to 6 as well as 11 and 12 to the effect that the housing 40 not only surrounds the LED light source 1 mounted on a circuit board 2, but also a cooling element 30 consisting of cooling ribs, cooling pins or the like, so that the coolant guided in a first coolant line 81 and entering the housing 40 via the coolant inlet 41 and leaving the housing 40 via the coolant outlet 42 flows around both the LED light source 1 and the cooling element 30 and emits the absorbed heat to the environment or to a heat-absorbing device via a cooling system 7.

Analogous to the representations of FIGS. 4 to 6 the optical window 5 arranged in front of the LEDs 1 in emission direction of the LEDs can be formed as plane-parallel plate or as lens, lens array or light mixing rod, in order to perform a beam formation and/or color mixing. In this embodiment, too, a dynamic beam formation can be achieved by an optical window 5 arranged in front of the LED light source 1 in a fluid-tight, but movable way. It can be coated with luminescent material and thus fulfill the function of a remote-phosphor light source.

The LEDs 1 mounted on the circuit board 2 are connected with a power supply cable 14 which is connected to an electronic controller, a mains unit or ballast 12. The control unit, mains unit or ballast 12 is connected with a voltage source via a mains cable 13.

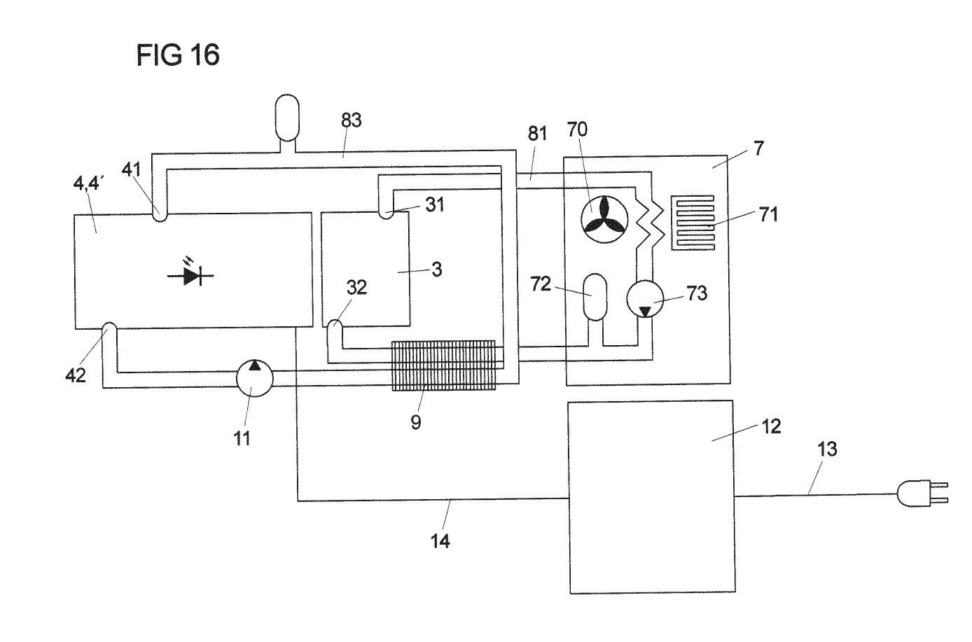

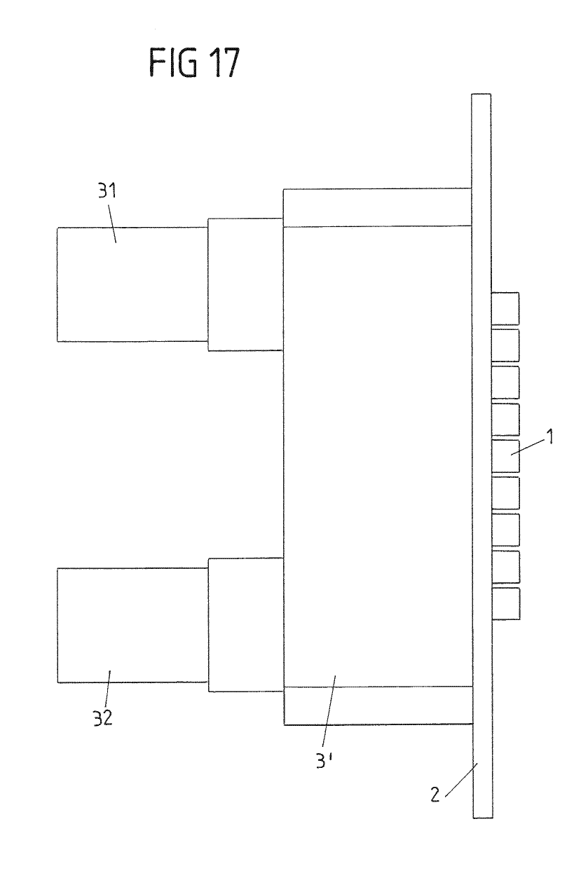

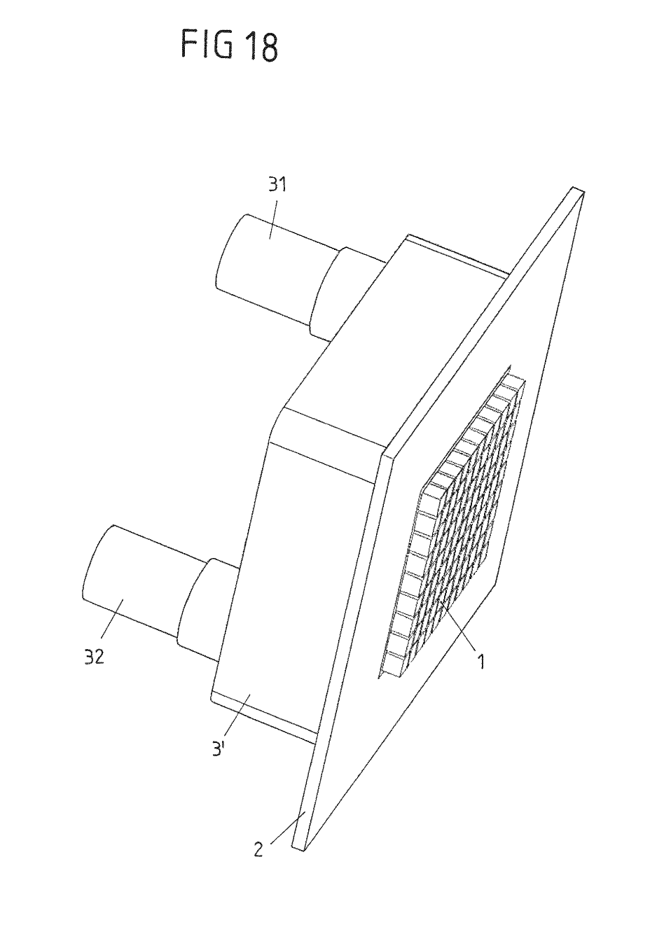

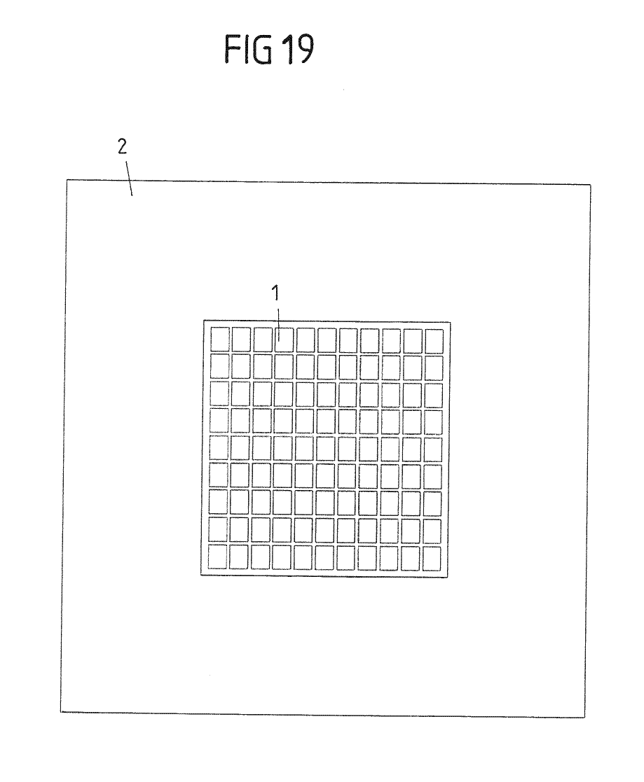

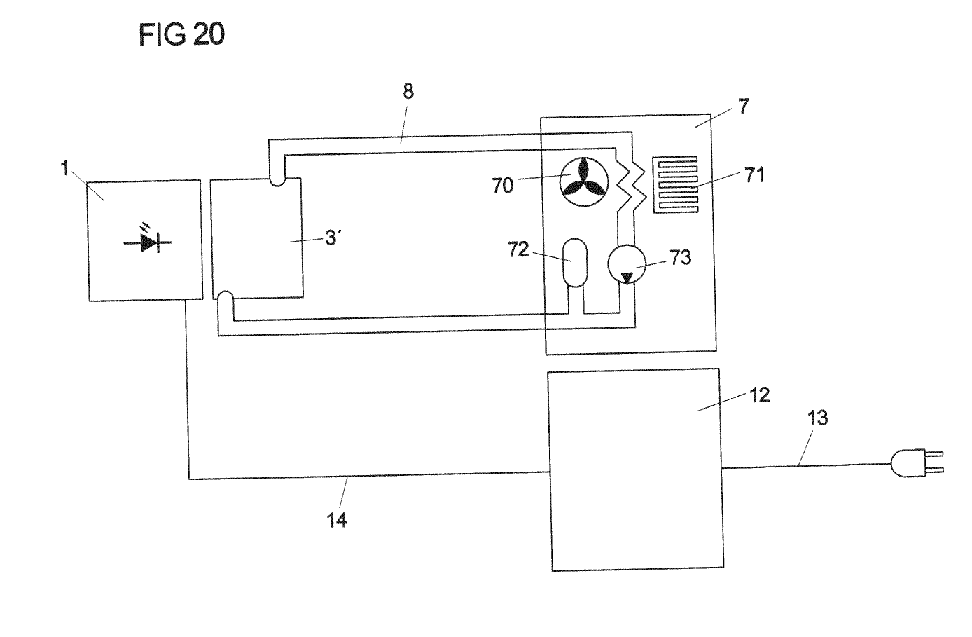

With reference to the schematic representations of FIGS. 11 to 16 various cooling systems 7a to 7e will be explained, wherein the type of cooling and recooling however is not limited to the illustrated systems.

The circulating air cooling system 7a as shown in FIG. 11 contains a heat sink 71 thermally coupled with the coolant lines 81, 82, a fan 70 for producing a stream of cooling air directed to the heat sink 71, and a coolant reservoir or a tank 72 for the coolant as well as a coolant pump 73 for producing a circulating stream of coolant.

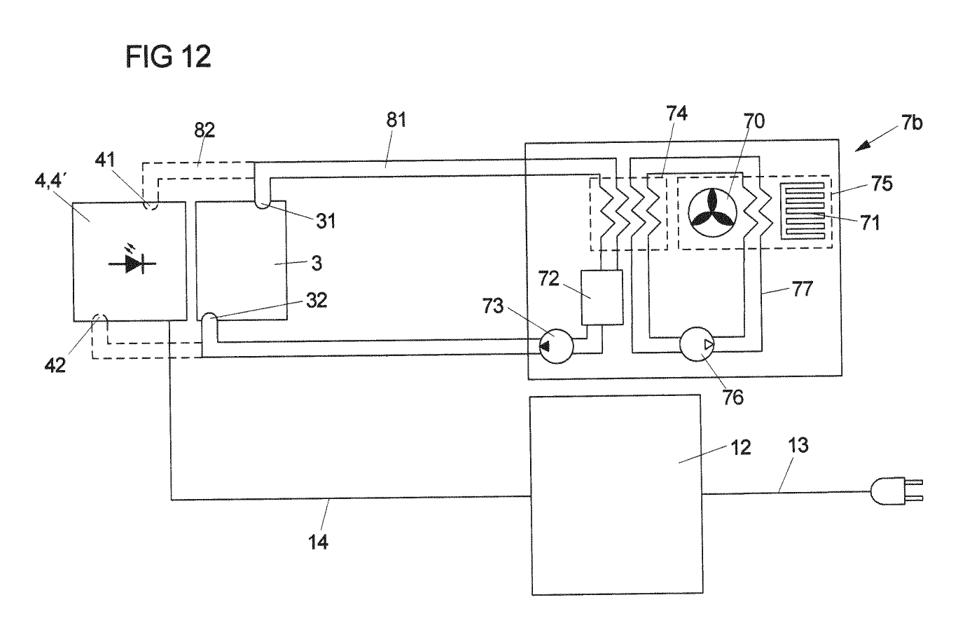

FIG. 12 shows a schematic representation of a cooling system formed as recooling system 7b with primary coolant circuit and secondary refrigerant circuit with a mechanical cooling device consisting of an evaporator 74 formed as heat exchanger with primary-side connection to the coolant lines 81, 82 and secondary-side connection to a refrigerant line 77 which connects the evaporator 74 with a condenser 75 via a compressor 76. In this exemplary embodiment, analogous to the arrangement according to FIG. 11, the condenser 75 includes a fan 70 and a heat sink 71 which emits the heat quantity transported via the refrigerant line 77 to the environment. The primary-side connection of the evaporator 74 corresponds to the arrangement according to FIG. 11 with a coolant reservoir or tank 72 and a coolant pump 73 to produce a circulating stream of coolant.

In the recooling system 7b as shown in FIG. 12 the coolant is cooled by the refrigerant, when it passes through the evaporator 74. The refrigerant absorbs the thermal energy, evaporates and is liquefied again by means of the compressor 76 and the condenser 75, wherein during the condensation the heat is emitted to the ambient air by means of the fan 70 and the heat sink 71.

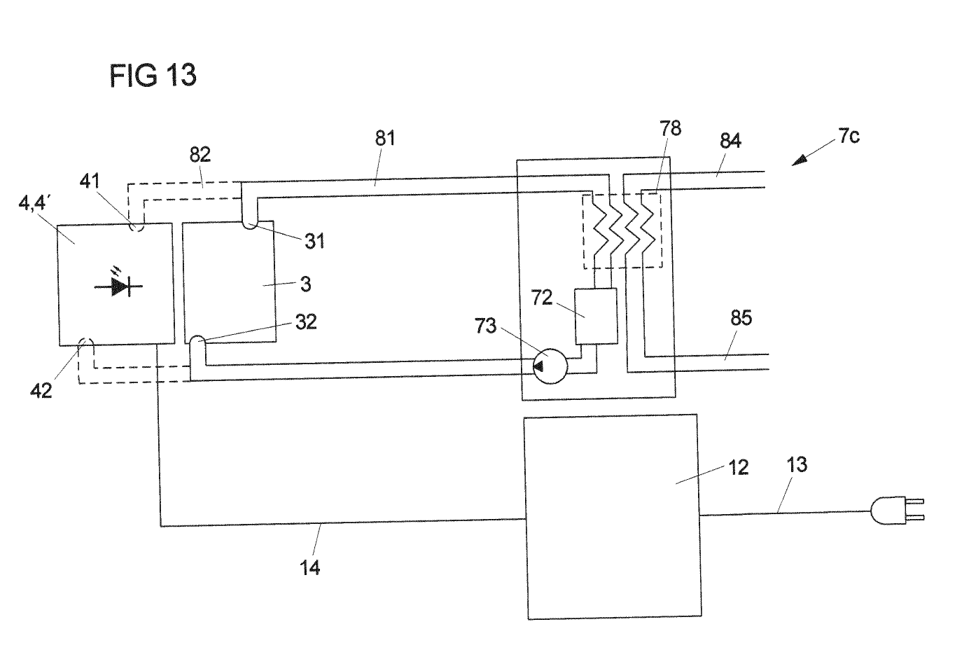

In the embodiment according to FIG. 13 the cooling system consists of a water exchange system 7c with a heat exchanger 78 which on the primary side is connected to the coolant lines 81, 82, to the coolant reservoir 72 for the coolant and to the coolant pump 73 for producing a circulating stream of coolant, while on the secondary side the heat exchanger 78 is connected to process water lines 84, 85. In this water exchange system 7c the coolant is passed from the primary circuit through the heat exchanger 78, where it is cooled by the colder process water supplied from outside.

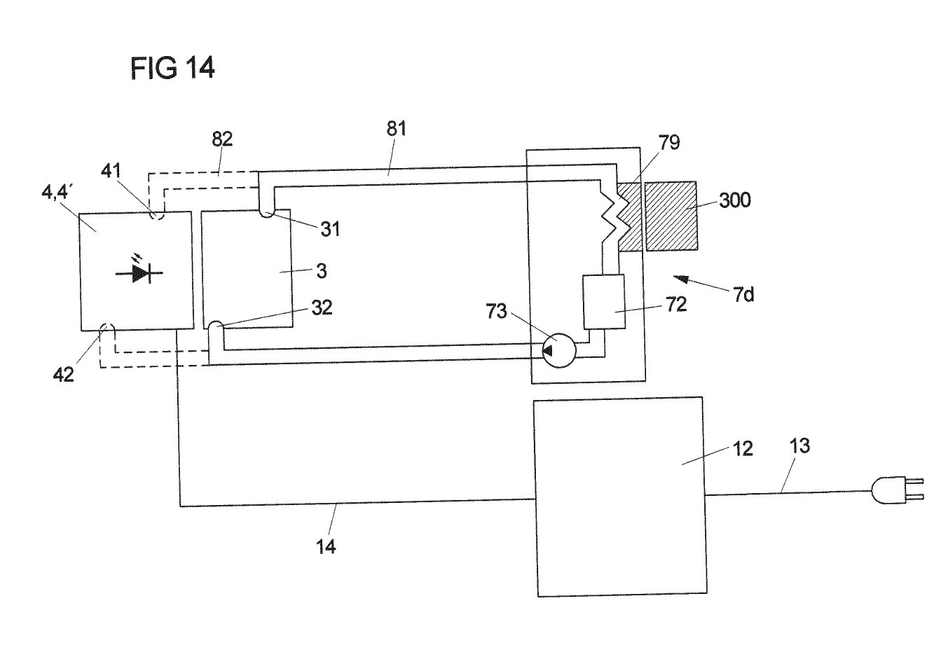

FIG. 14 shows a schematic representation of the use of a heat-absorbing device formed as cold pack 300 in an indirect cold pack system 7d, in which the cold pack 300 is flange-mounted to the coolant lines 81, 82. For this purpose, a heat exchanger 79 on the primary side is connected to the coolant circuit consisting of the coolant lines 81, 82, the coolant reservoir 72 for the coolant and the coolant pump 73 for producing the circulating stream of coolant, and on the secondary side is provided with a corresponding device for accommodating the cold pack 300 or for flange-mounting the cold pack 300.

FIG. 15 shows a schematic representation of the formation of a cooling system as heat-absorbing direct cold pack system 7e with a cold pack 300, which is directly flange-mounted to the housing 4, 40 accommodating the LED light source 1 or to the coolant line. The cold pack 300 absorbs the thermal energy emitted by the LED light source 1 for a limited period of time and upon reaching a specified temperature is then replaced by a second cold pack 300 prepared for absorbing thermal energy.

In an alternative arrangement according to the schematic representation of FIG. 12 the coolant flowing around the LED light source 1 is guided in a coolant line 83 which forms a secondary circuit and via a heat exchanger 9 is thermally coupled with a primary cooling circuit which includes a coolant line 81 which via the first coolant inlet 31 and the first coolant outlet 32 is connected with the cooling plate 3 and a cooling system 7. The secondary cooling circuit includes a reservoir 10 for taking up cooling liquid and a coolant pump 11 for the transport of the coolant through the secondary circuit. The cooling system 7 can be formed analogous to the cooling systems 7a to 7c described above with reference to FIGS. 11 to 13.

### LIST OF REFERENCE NUMERALS

1 LED light source
2 circuit board
3 cooler
3′ cooling plate
4 housing
5 optical window
7; 7a-7e cooling system
8 coolant line
9 heat exchanger
10 reservoir
11 coolant pump
12 mains unit or ballast
13 mains cable
14 power supply cable
30 cooling element (cooling ribs, cooling pins)
31, 41 coolant inlet
32, 42 coolant outlet
40 housing
50 plane-parallel glass or plastic plate
51 lens
52 scattering plate
70 fan
71 heat sink, cooling fins or cooling ribs
72 coolant reservoir
73 coolant pump
74 evaporator
75 condenser
76 compressor
77 refrigerant line
78, 79 heat exchanger
81-83 coolant lines
84, 85 process water lines
300 cold pack

1. A headlight with an LED light source comprising:
at least one light-emitting diode arranged on a circuit board;
a housing enclosing the LED light source, wherein the housing:
includes at least one light exit surface through which the light emitted by the LED light source exits; and:
encloses the LED light source in a liquid- or gas-tight way and includes at least one coolant inlet and one coolant outlet for a liquid or gaseous coolant.

2. The headlight according to claim 1, wherein the housing encloses the LED light source and a cooling element connected with the circuit board, which in particular consists of cooling ribs.

3. The headlight according to claim 1, wherein the light exit surface is formed as optical element or optical window.

4. The headlight according to claim 1, wherein the optical element or optical window is connected with the housing in a liquid- or gas-tight way.

5. The headlight according to claim 1, wherein the optical element or optical window consists of a transparent, optical plastic material or glass.

6. The headlight according to claim 1, wherein the optical element or optical window consists of a plane-parallel glass or plastic plate.

7. The headlight according to claim 1, wherein the optical element or optical window is optically active for beam formation and/or color mixing.

8. The headlight according to claim 1, wherein the optical element or optical window includes curved or stepped optical surfaces for light guidance.

9. The headlight according to claim 8, wherein the optical element or optical window consists of a lens, a lens array, a scattering plate or of a light mixing rod.

10. The headlight according to claim 8, wherein the optical element or optical window is coated with a luminescent material.

11. The headlight according to claim 1, wherein the distance and/or the orientation of the optical element, optical window or the housing with respect to the position of the LED light source is variable for the dynamic beam formation of the light emitted by the at least one LED of the LED light source.

12. The headlight according to claim 1, wherein the refractive index and the spectral transmission and reflection of the optical element or optical window, the surface of the LED light source, a primary lens of the LED light source as well as the coolant are adjusted to achieve a specified lighting result, in particular a specified radiation angle or a specified light output.

13. The headlight according to claim 1, wherein within the housing or on a wall surface of the housing further optical elements such as reflectors or lenses are arranged.

14. The headlight according to claim 1, wherein the circuit board is formed as cooling plate or is connected with a cooler.

15. The headlight according to claim 13, wherein the coolant flows through the circuit board formed as cooling plate and/or through the cooler and/or the housing.

16. The headlight according to claim 1, characterized by a cooling system containing the coolant, which cools the coolant down to a specified service temperature.

17. The headlight according to claim 15, wherein the cooling system is arranged within the headlight.

18. The headlight according to claim 1, wherein the cooling system is arranged outside the headlight.

19. The headlight according to claim 1, wherein the LED light source and/or the cooler are traversed by a coolant which is movable by a cooling system distributed over several systems or appliances and can be cooled down to service temperature.

20. The headlight according to claim 1, wherein the LED light source is arranged in a secondary cooling circuit and the cooling plate is arranged in a primary cooling circuit and that the primary and secondary cooling circuits are thermally coupled via a heat exchanger.

21. The headlight according to claim 1, wherein the cooling system includes a coolant reservoir, a coolant pump, a heat sink, cooling fins or cooling ribs and a fan.

22. The headlight according to claim 1, wherein the cooling system consists of a heat-absorbing exchangeable cold pack.

23. The headlight according to claim 1, wherein the cooling system is connected to a central cooling device with a coolant distribution via a specified standardized coolant port.

24. The headlight according to claim 22, wherein the standardized coolant port includes an interface for an electrical connection and/or a control bus for controlling and regulating the LED light source.

25. The headlight according to claim 22, wherein the standardized coolant port is connectable with a hybrid cable which includes the interfaces for an electrical connection, electrical control signals, a supply voltage and the cooling liquid.

26. The headlight according to claim 1, wherein a central cooling system dissipates the heat emitted by the coolant and that the headlight includes a pump for the coolant.

27. The headlight according to claim 1, wherein the cooling system consists of a central cooling unit with central coolant distribution and coolant regulation of a generator vehicle for the power supply of several cooling devices connected to the generator vehicle.

28. The headlight according to claim 1, wherein the at least one LED of the LED light source consists of a light-emitting diode in a ceramic or plastic housing which is mounted on the circuit board.

29. The headlight according to claim 28, wherein the LED of the LED light source arranged in a ceramic or plastic housing is covered with an optically active or inactive material.

30. The headlight according to claim 1, wherein the at least one LED consists of an LED chip which is mounted on the circuit board in chip-on-board technology.

31. The headlight according to claim 1, wherein the color locus of the LEDs of the LED light source can be regulated and stabilized electronically in dependence on the temperature of the LEDs.

32. The headlight according to claim 1, wherein the color locus of the LEDs of the LED light source can be stabilized by regulating the coolant temperature, the coolant flow or the rotational speed of the fan at the heat exchanger.

33. The headlight according to claim 30, wherein in a mixed operation the color locus of the LEDs of the LED light source can be regulated and stabilized both in dependence on the temperature of the LEDs and in dependence on the coolant temperature, the coolant flow or the rotational speed of the fan at the heat exchanger.

34. The headlight according to claim 32, wherein in a normal operation the color locus of the LEDs of the LED light source can be stabilized up to a specifiable ambient temperature by regulating the coolant temperature, the coolant flow or the rotational speed of the fan at the heat exchanger and upon exceedance of the specified ambient temperature can be stabilized in an intensive operation by electronic regulation of the LED light source.
